(19) United States
(12) Patent Application Publication
(10) Pub. No.: US 2012/0213622 A1
(43) Pub. Date: Aug. 23, 2012

(54) LEVEL LIFT DETACHABLE TRAILER SYSTEM

(76) Inventor: DAVID L. DOSKOCIL, San Bernardino, CA (US)

(21) Appl. No.: 13/372,404

(22) Filed: Feb. 13, 2012

Related U.S. Application Data
(60) Provisional application No. 61/444,675, filed on Feb. 18, 2011.

(51) Int. Cl. B60P 1/02

(52) U.S. Cl. 414/495

(57) ABSTRACT

A hauling system that has a chassis and a fully detachable cargo bed. The cargo bed can be elevated into a fully loaded, ready for transportation position, and fully unloaded, while remaining level to the ground on which the overall device is operated. The chassis and the cargo bed are equipped with beveled pieces that interact to help guide the operator when maneuvering the chassis into a staged position on the cargo bed. The cargo bed of the detachable level lift hauling system may be secured to the head end of the chassis when the cargo bed has been pulled up to the transportation position.

### RELATED APPLICATIONS

This application claims the benefit of U.S. Provisional Patent Application No. 61/444,675, filed Feb. 18, 2011, which is hereby fully incorporated by reference.

### FIELD

The present disclosure relates generally to the field of hauling cargo on highways with motor vehicles and more specifically to cargo carried with trailers.

### BACKGROUND

The present patent document pertains generally to the field of hauling cargo on highways with motor vehicles and more specifically to cargo carrying devices such as trailers.

A loaded cargo is usually carried on a hauling cargo bed which is mounted on a truck chassis frame, such as the typical long-haul semi-trucks and trailers seen on the road. In order to load the truck or trailer, however, the cargo must be lifted onto the hauling bed. Many designs have sought to ease this task. U.S. Pat. No. 2,485,300 issued to Lisota uses a tilting and moving bed to load or unload a truck. Many refinements of this method have been used to lift up large cargo containers on truck chassis.

LaMora in U.S. Pat. No. 5,460,473 shows a system using a trailer to haul two containers in line.

Alternately, U.S. Pat. No. 6,099,232 to Dixon shows a smaller cargo bed loaded into a pickup truck. Although these methods are widely used today, they are not practical for unpacked cargoes, nor can they be used to load or unload live animals.

U.S. Pat. No. 2,230,014 issued to Haven describes a lifting/lowering trailer using a system of cams and links. Verschage in U.S. Pat. No. 4,372,572 uses cams, links and hydraulic cylinders to lift heavy loads, such as fork lifts.

U.S. Pat. No. 5,630,693 issued to Sobina shows a design of a level lift trailer bed which is kept in alignment by inner sliding telescoping guides as it is lifted by hydraulic cylinders at each corner of the chassis. In each of these devices, the cargo or load carrying member is a permanent integral part of the trailer.

These systems all work to a degree, but have drawbacks, particularly when the cargo to be hauled is quite heavy, bulky, top-heavy or otherwise difficult to handle. For such cargo, a preferable method for loading is to have the cargo bed flat on the ground so that the cargo (a fork lift, for example), can be simply driven onto the cargo bed and secured there. Then, the entire cargo bed, with cargo loaded and secured, can be elevated into position on the trailer for transportation. Unloading is accomplished through a reverse process. Another consideration in this type of system is the manner in which the loaded cargo bed is elevated into position. To load the cargo bed onto the chassis an operator maneuvers the vehicle chassis rearwardly, sliding the chassis onto the cargo bed until the lifting device on the chassis comes into latching contact with the cargo bed. It is desirable to have a close mating between the cargo bed and hauling system chassis so as to minimize movement between them during transportation. However, it can be difficult to guide the hauling system chassis into the correct mating position with the cargo bed.

Therefore, there is a need in the art for an improved hauling system, in which large, bulky and difficult-to-handle cargo may be safely loaded and unloaded by a single operator. There is also a need for a system in which the mating of the cargo bed and the hauling system chassis may be accomplished quickly and easily, without multiple attempts or more than one person being involved.

### SUMMARY OF THE EMBODIMENTS

As described more fully below, the embodiments of the present patent document permit an improved hauling system, in which large, bulky and difficult-to-handle cargo may be safely loaded and unloaded by a single operator. Further aspects, objects, desirable features, and advantages of the embodiments disclosed herein will be better understood and apparent to one skilled in the relevant art in view of the detailed description and drawings that follow, in which various embodiments are illustrated by way of example. It is to be expressly understood, however, that the drawings are for the purpose of illustration only and are not intended as a definition of the limits of the claimed embodiments.

To this end, a hauling system is provided, where the hauling system comprises a chassis having an open space in the center, and inwardly beveled guides disposed on opposite sides of the chassis at a mouth to the open space, and a removable cargo bed, sized to fit into the open space and including outwardly beveled guides disposed on opposite sides of a front of the removable cargo bed so as to be operably received by the inwardly beveled guides when the cargo bed is initially being received into the open space.

In some embodiments, the chassis may be a trailer. In another embodiment, the cargo bed may be a container.

In a preferred embodiment, the hauling system may be a detachable level lifting trailer system. In some embodiments, the chassis further comprises a tongue structure coupled to a head structure. In yet another embodiment, the chassis further comprises a hydraulic cylinder coupled to the tongue structure and the cargo bed for raising up the cargo bed to a transport position.

In yet another embodiment, the cargo bed further comprises two side walls, where the side walls comprise a plurality of inclined channel tracks disposed to the side walls, each of the inclined channel tracks is sized to receive one of the lifting rollers, wherein the lifting rollers are located in the inclined channel tracks when the cargo bed is raised up to a transport position.

In a preferred embodiment, a lifting roller disposed nearer to the mouth of the chassis may be at a position higher than that disposed nearer to a front head structure.

In yet another embodiment, the cargo bed further comprises two side walls, a head end, and a plurality of inclined channel tracks angled substantially at 45 degrees, each of the inclined channel tracks is parallel to one another and disposed on the outer surface of the side walls, each of the inclined channel tracks are purposed to receive a lifting roller from the head end of the cargo bed and extending to the upper ends of the inclined channel tracks.

In yet another embodiment, the hydraulic cylinder further comprises a hydraulic cylinder shaft and a hook, wherein the hydraulic cylinder is powered or pressured to move between an up and a down position. In another embodiment, the hydraulic cylinder is powered or pressured to move the cargo bed between an up and a down position.

In a preferred embodiment, a detachable level lift hauling system, comprises a chassis having a front end, a back end, and an open space in the center, a detachable cargo bed, sized to enter through the back end and fit into the open space, wherein the detachable cargo bed may be secured to the front end of the chassis.

In another embodiment, the detachable cargo bed is secured to the front end by a hook. In yet another embodiment, the hook is coupled to the front end of the chassis. In some embodiments, the front end of the chassis further comprises a spring, wherein the spring biases the hook into a locking position with a bar on the cargo bed. In yet another embodiment, the cargo bed is lifted into an elevated position on the chassis, and then secured.

In a preferred embodiment, a hauling system comprises a chassis having an open end and an open space in the center, a removable cargo bed sized to fit into the open space, and wherein at least one of either the chassis or the removable cargo bed include alignment guides to move the cargo bed into alignment for loading into the open space.

In some embodiments, the alignment guides further comprise a plurality of beveled pieces disposed on a back end of the chassis. In another embodiment, the alignment guides further comprise a plurality of beveled pieces disposed on a front end of the cargo bed.

In yet another embodiment, the chassis may be a trailer. In yet another embodiment, the cargo bed may be a container. In some embodiments, the hauling system may be a detachable level lifting trailer system.

A further feature of some embodiments, is the ability to release a cargo bed fully and completely from the trailer chassis. Therefore, the cargo bed may be loaded and unloaded while the bed is sitting on the ground and detached from the trailer. In other words, a single trailer that can move a variety of cargo beds whether loaded or unloaded, as the fully detachable cargo bed assemblies are interchangeable. A single operator may unload one fully loaded cargo bed, leaving the cargo securely and safely fastened on the bed for later use, and then immediately re-load with another interchangeable, pre-loaded cargo bed. This system feature uniquely suits the delivery needs of the manufacturing and the construction industries, among many others.

It is another object of the present embodiments to provide a safe and easy transportation of live cargoes such as horses. A ground level loading and unloading of horses or other animals removes the danger and risk of injury to these animals.

It is yet a further object of the present embodiments disclosed herein to provide an alternate design which may be incorporated into specialized systems for use in areas where very high theft potential prevails. The feature of raising up and lowering down a trailer bed allows for an inexpensive single axle custom cargo bed to be used in areas where the equipment must be left unattended for an extended period of time. Thus, the tires and wheels of the trailer are not exposed to danger since they do not have to be left behind with the cargo.

To these ends, the level lifting trailer with the option of multiple detachable cargo beds in the present patent document provides a safe and economical cargo-transfer and delivery system.

These and other objects, features, aspects, and advantages of the present embodiments will become better understood with reference to the following description and accompanying drawings.

### BRIEF DESCRIPTION OF THE DRAWINGS

FIG. 1 illustrates a perspective view of one exemplary embodiment of a detachable level lift hauling system.

FIG. 2 illustrates a perspective view of the embodiment of the exemplary hauling system of FIG. 1 showing the cargo bed in a fully detached position behind the empty hauling system chassis, in position to be backed onto the cargo bed.

FIG. 3 illustrates a top view of the embodiment of the exemplary hauling system of FIG. 1, showing the detached cargo bed juxtaposed behind the empty hauling system chassis, in position to be backed onto the cargo bed.

FIG. 4 illustrates a side-view of the embodiment of the hauling system shown in FIG. 3.

FIG. 5 illustrates a side-view of the embodiment of the hauling system shown in FIG. 3, with the chassis in its staged position pre-elevation, in which the chassis has been backed onto the cargo bed, and the elevating device on the chassis has made latching contact with the cargo bed.

FIG. 6 illustrates a side-view of the embodiment of the hauling system shown in FIG. 5, where the elevating device has pulled the cargo bed into the fully up and fully loaded position.

FIG. 7 illustrates a side view of one embodiment of the chassis of the exemplary hauling system of FIG. 1.

FIG. 8 illustrates a side view of an embodiment of a cargo bed for use with a detachable level lift hauling system.

FIG. 9 illustrates a front view of the embodiment of a cargo bed of FIG. 8.

FIG. 10 illustrates a front view of an embodiment of a chassis for use with a detachable level lift hauling system.

FIG. 11 illustrates a side view of a portion of the embodiment of the chassis of FIG. 10.

FIG. 12 illustrates a side view of a portion of an embodiment similar to FIG. 11, with its lifting device piston extended and latched to the cargo bed.

FIG. 13 illustrates a side view of a portion of another embodiment similar to FIG. 12, with the cargo bed pulled up and elevated fully into the transportation position, and locked into place.

FIG. 14 illustrates a top view of an embodiment of a detachable level lift hauling system, where the beveled pieces are extensions of other pieces of the chassis.

FIG. 15 illustrates a top view of an embodiment of a detachable level lift hauling system, where the beveled pieces are coupled to the head end of the cargo bed.

FIG. 16 illustrates a top view of another embodiment of a detachable level lift hauling system, where some beveled pieces are extensions of other pieces of the chassis, and other beveled pieces are extensions of the cargo bed.

FIG. 17A illustrates a portion of a top view of an embodiment of a detachable level lift hauling system, where the beveled pieces are curved extensions of other pieces of the chassis.

FIG. 17B illustrates a portion of a top view of an embodiment of a detachable level lift hauling system, where the beveled pieces are curved extensions of the back end of the chassis.

FIG. 17C illustrates a portion of a top view of an embodiment of a detachable level lift hauling system, where the beveled piece comprises a curved shape.

FIG. 17D illustrates a portion of a top view of an embodiment of a detachable level lift hauling system, where the beveled piece comprises a triangle shape.

### DETAILED DESCRIPTION OF THE EMBODIMENTS

Description will be hereinafter made of an embodiment of a level lift trailer with detachable cargo bed according to the present patent document with reference to the drawings. Additionally, in the following descriptions of the drawings, the same or similar portions are assigned with the same or similar reference symbols. It should be noted that each drawing is a schematic diagram, and may represent different dimensional ratios and the like from those of the actual hauling system. Hence, specific dimensions and the like should be determined in consideration of the following descriptions. Furthermore, as a matter of course, different drawings include elements which have different dimensional relations and ratios.

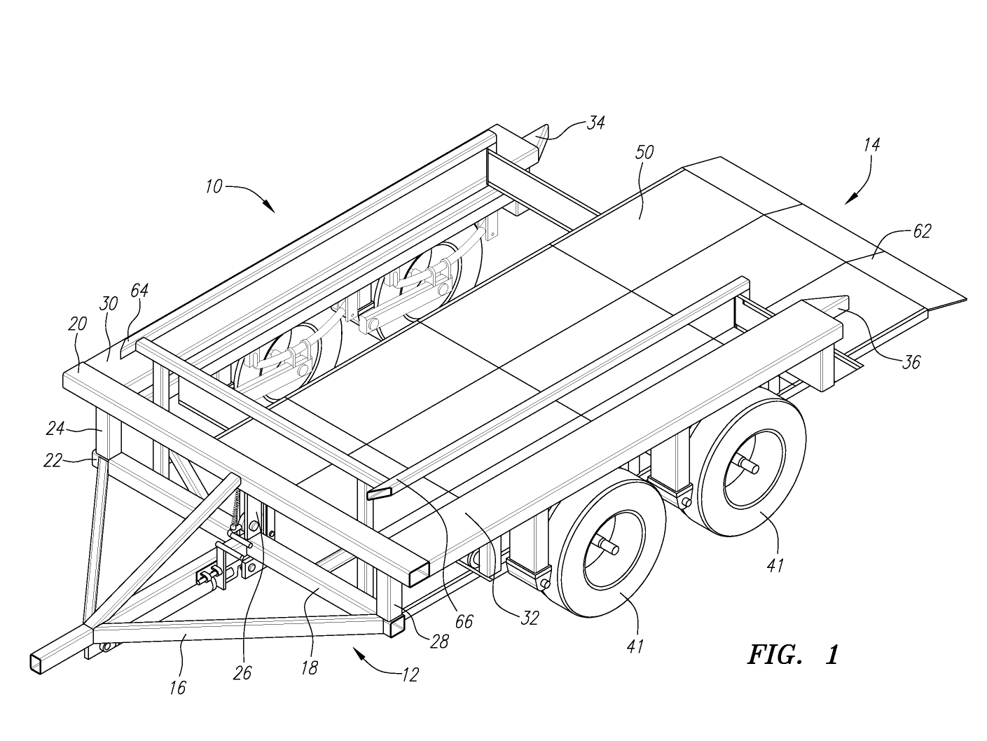

Referring to the drawings, FIG. 1 illustrates a perspective view of one exemplary embodiment of a detachable level lift hauling system. Hauling system 10 includes a chassis 12 and a cargo bed 14. In FIG. 1, the cargo carrying device or hauling system 10 is shown as a trailer but the hauling system could also be the rear portion of a vehicle such as a truck or other self-motive or self-propelled device.

In the embodiment of FIG. 1, the chassis 12 has a tongue assembly 16 which is attached to a front end 18. The front end 18 is constructed from upper and lower cross pieces 20 and 22, and three vertical bars 24, 26 and 28. In the embodiment shown in FIG. 1, the chassis further has two rearwardly extending upper frame beams 30 and 32. On the distal ends of the bars 30 and 32 are alignment guides or inwardly beveled pieces 34 and 36 further comprising the back end of the chassis 12. Further comprising the head end 60 of the cargo bed 14 are alignment guides or outwardly beveled pieces 64. As the operator maneuvers the chassis 12 into a staged position onto the cargo bed 14, the inwardly beveled pieces 34 and 36 may interact with the outwardly beveled pieces 64 to help guide the chassis 12 and the cargo bed 14 into the proper alignment. A bevel or beveled piece 34, 36, or 64 may be any shape, angled, curved, circular, or any shape that assists in the mating of the chassis 12 to the cargo bed 14.

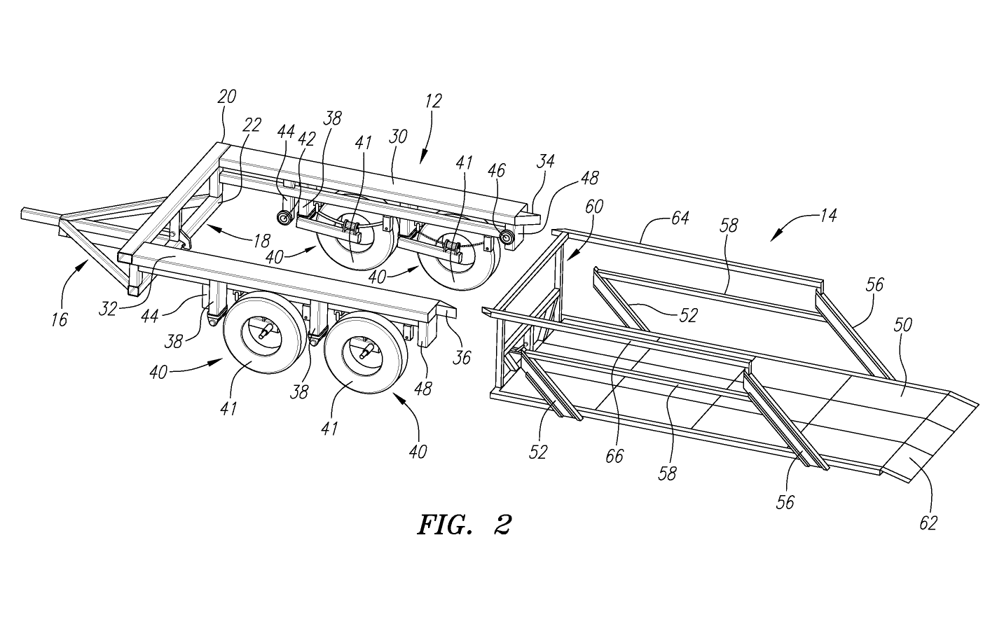

FIG. 2 illustrates a perspective view of the embodiment of the exemplary hauling system 10 of FIG. 1 showing the cargo bed 14 in a fully detached position behind the empty hauling system chassis 12, in position to be backed onto the cargo bed 14. The chassis 12 further comprises a number of lateral support struts 38 to which are attached an axle and wheel assembly 40. In the embodiment shown in FIG. 2, the chassis 12 has four wheels 41, two on each side. In other embodiments, any number of wheels or any size may be used. In selecting the size and number of wheels, consideration may be given to the size and shape of the chassis 12 and the ground over which the chassis 12 will be transported. Generally speaking, the cargo bed 14 may be any bed or container useful in transporting cargo, such as a container, cargo box, or horse compartment.

In the embodiment of FIG. 2, a pair of inwardly extending front lifting rollers 42 are located on struts 44. A second pair of inwardly extending rear lifting rollers 46 are located on struts 48. The front lifting rollers 42 are mounted at a level lower than the rear lifting rollers 46.

In the embodiment of FIG. 2, the cargo bed 14 has a bed 50 that is attached to side structures, each comprising a pair of rear inclined channel tracks 56 that are angled approximately 45 degrees from vertical, and a pair of front inclined channel tracks 52, also at an approximately 45 degree angle. Support rails with outwardly beveled head ends 64 and 66 are attached to the tracks and the head end structure 60. Support rails 58 are attached to the inclined channel tracks 52 and 56, and the inclined channel tracks 52 and 56 are attached to the bottom struts 61 to complete the box-like cargo assembly 14. A ramp portion 62 attached to the rear of the bed facilitates loading. In the embodiment shown in FIG. 2, the outwardly beveled pieces 64 and 66 are also the upper support rails of the side structures of the cargo bed 14. In other embodiments, the outwardly beveled pieces 64 and 66 may be separate pieces from the upper support rails for the cargo bed 14.

In the embodiment of FIG. 2, the front inclined channel tracks 52 are sized to receive the front lifting rollers 42, while the rear inclined channel tracks 56 are sized to receive the rear lifting rollers 46. The inclined channel tracks 52 and 56 and the lifting rollers 42 and 46 may be of any size so long as there is reasonably close mating between the inclined channel tracks 52 and 56 and lifting rollers 42 and 46 so as to avoid or lessen movement during transportation. In one embodiment, a lifting roller diameter of 5.5 inches, and inclined channel track inside width of 5.62 inches has been found effective. In another embodiment, enlarging the opening of the inclined channel tracks 52 and 56 to 12 inches in width has also been found effective. The 12 inch width of the inclined channel tracks 52 and 56 allows for the lifting rollers 42 and 46 to self-align to the inclined channel tracks 52 and 56 even when the chassis 12 and the cargo bed 14 are at different heights or parallels.

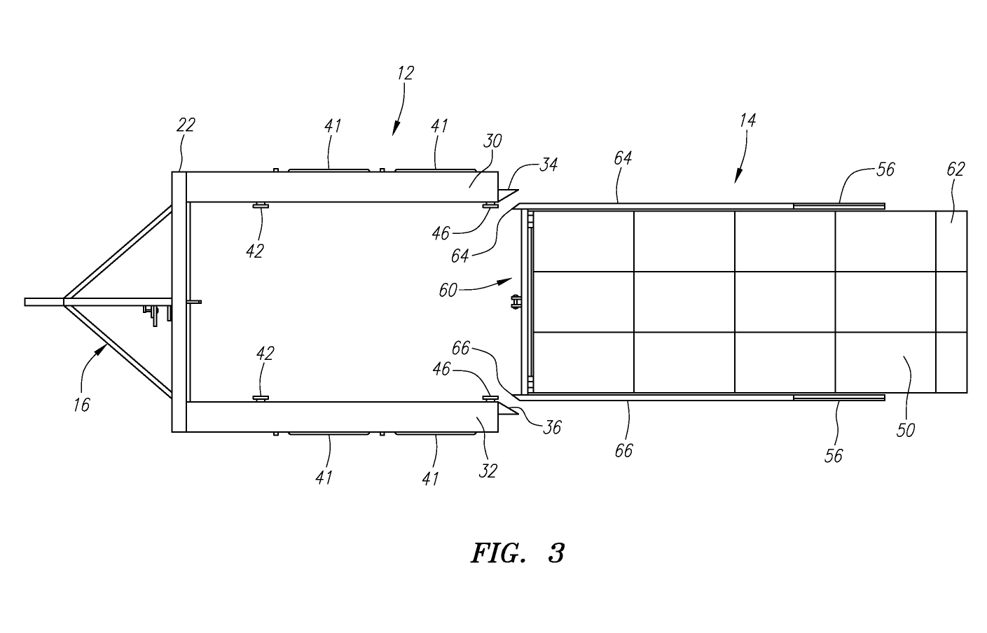

FIG. 3 illustrates a top view of the embodiment of the exemplary hauling system 10 of FIG. 1, showing the detached cargo bed 14 juxtaposed behind the empty hauling system chassis 12, in position to be backed onto the cargo bed 14. When the operator backs the chassis 12 onto the cargo bed 14, the inwardly beveled pieces 34 and 36 may interact with the outwardly beveled pieces 64 to guide the assemblies into a mated position. In a mated position, the chassis 12 is maneuvered such that the cargo bed 14 arrives in a locking position inside the open space of the chassis 12.

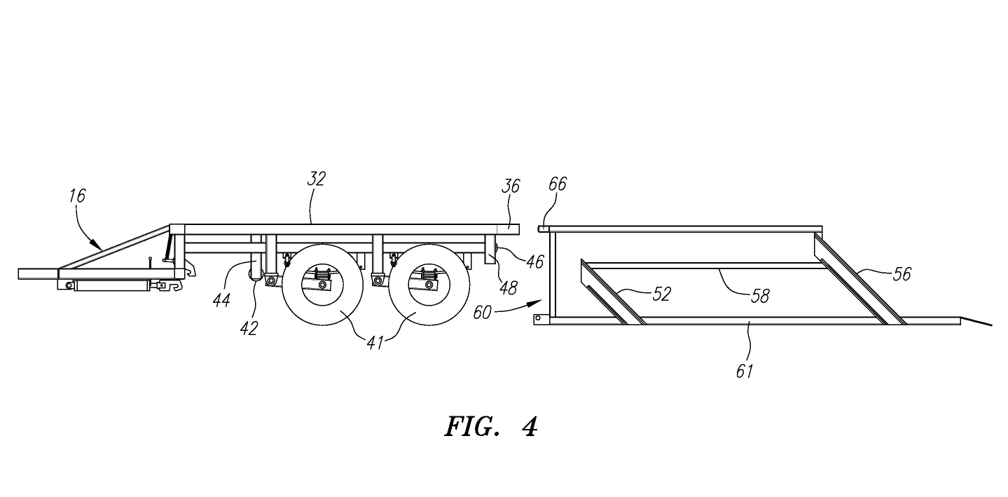

FIG. 4 illustrates a side-view of the embodiment of the hauling system shown in FIG. 3. In FIG. 4, the inwardly beveled pieces 34 and 36 are at substantially the same elevation as the outwardly beveled pieces 64, so that the inwardly beveled pieces 34 and 36 may interact with the outwardly beveled pieces 64 to guide the assemblies into a mated position. Also shown in FIG. 4, on the front portion of the cargo bed 14 are outwardly beveled pieces 64. The front inclined channel tracks 52 are sized to receive the front lifting rollers 42, while the rear inclined channel tracks 56 are sized to receive the rear lifting rollers 46. This allows for easier mating between the lifting rollers 42 and 46 with the inclined channel tracks 52 and 56.

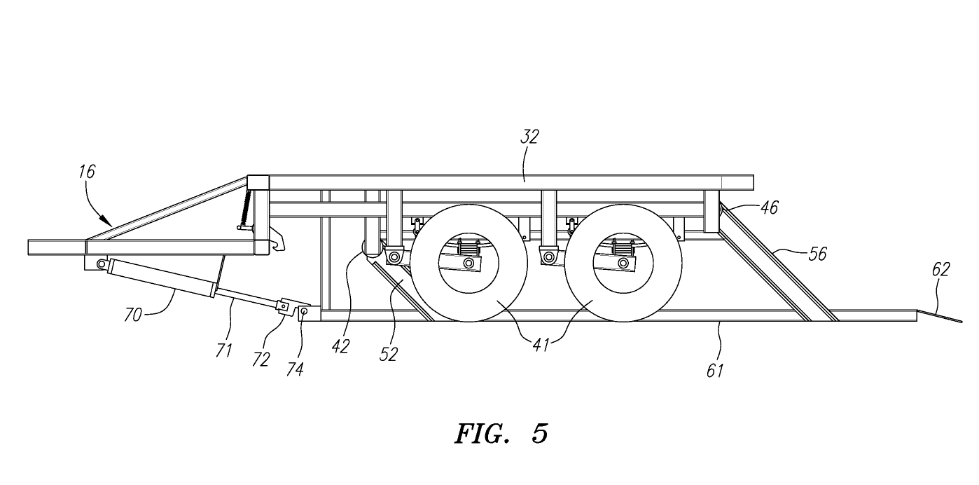

FIG. 5 illustrates a side-view of the embodiment of the hauling system 10 shown in FIG. 3, with the chassis 12 in its staged position pre-elevation, in which the chassis 12 has been backed onto the cargo bed 14, and the elevating device on the chassis has made latching contact with the cargo bed 14. The tongue assembly 16 has a hydraulic cylinder 70, hydraulic cylinder shaft 71, and hook 72, wherein the hook 72 is designed to be attachable to and detachable from a fixed bar 74 on the cargo bed. A package engine, a hydraulic pump, a reservoir and a valve can be mounted in the tongue assembly area. The hydraulic cylinder 70 and hydraulic cylinder shaft 71 that comprises an elevating device may be any type of lifting or elevating device that can lift or elevate the cargo bed 14 to a locking position. In other embodiments, the elevating device may be a piston arm of an actuator, a winch and cable system, or any other lifting or elevating device. In another embodiment, the hydraulic cylinder may be a horizontal pull hydraulic cylinder. In another embodiment, the hydraulic cylinder may further comprise a hydraulic cylinder shaft and a hook, wherein the hydraulic cylinder may be powered or pressured to move between an up or down position. In yet another embodiment, the hydraulic cylinder may be powered or pressured to move the cargo bed between an up and a down position. In another embodiment, the up position may be a transport position, and a down position may be an unloading or loading position.

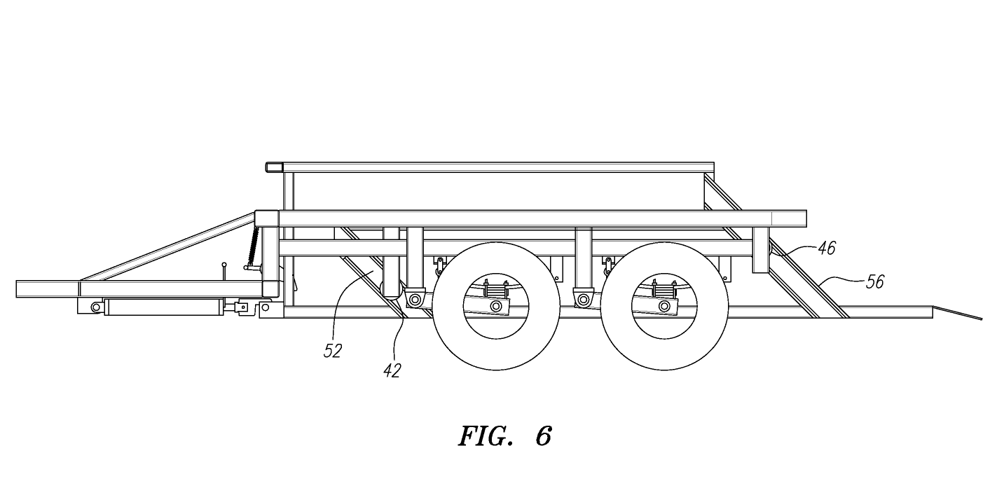

FIG. 6 illustrates a side-view of the embodiment of the hauling system 10 shown in FIG. 5, where the elevating device, hydraulic cylinder 70 and hydraulic cylinder shaft 71, has pulled the cargo bed 14 into the fully up and fully loaded position. In FIG. 6, the cargo bed 14 is shown resting inside the previously open space of the chassis 12. The front lifting rollers 42 are resting inside the inclined channel tracks 52, while the rear lifting rollers 46 are resting inside the inclined channel tracks 56.

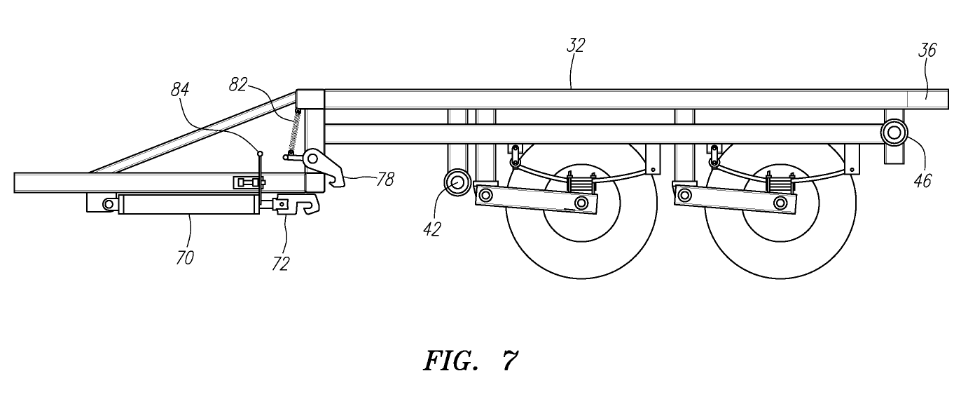

FIG. 7 illustrates a side view of one embodiment of the chassis 12 of the exemplary hauling system of FIG. 1. The chassis 12 further comprises two rearwardly extending upper frame beams 30 and 32. On the distal ends of the bars 30 and 32 are inwardly beveled pieces 34 and 36. In FIG. 7, the locking hook 78 is shown without the pin 80 and the cargo bed 14. The spring 82 biases the locking hook 78 into a locking position. The latch 83 and holder 84 are shown holding the hydraulic cylinder 70 and hook 72 into a locking position, without the cargo bed 14. Also shown in FIG. 7 are the front and rear lifting rollers 42 and 46.

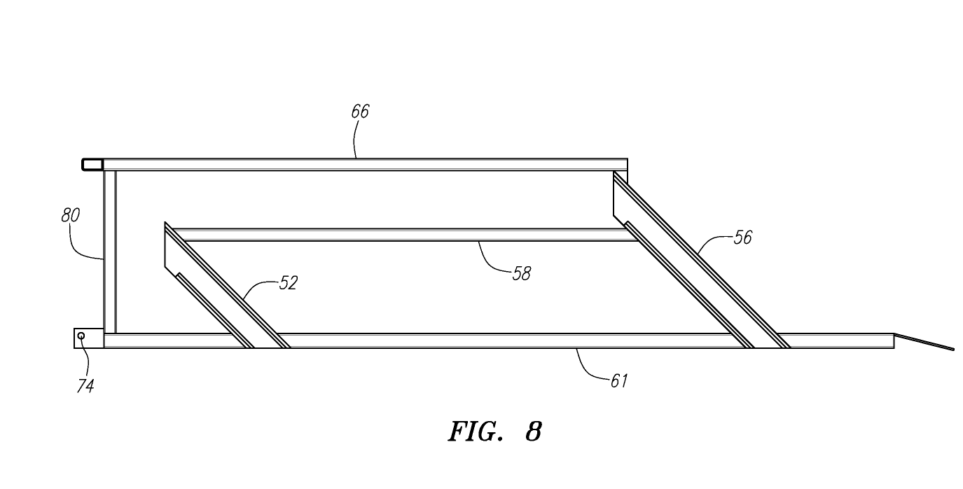

FIG. 8 illustrates a side view of an embodiment of a cargo bed 14 for use with a detachable level lift hauling system. In FIG. 8, the pin 80 is shown without the locking hook 78 and chassis 12. The fixed bar 74 is also shown without the hydraulic cylinder 70 and hook 72.

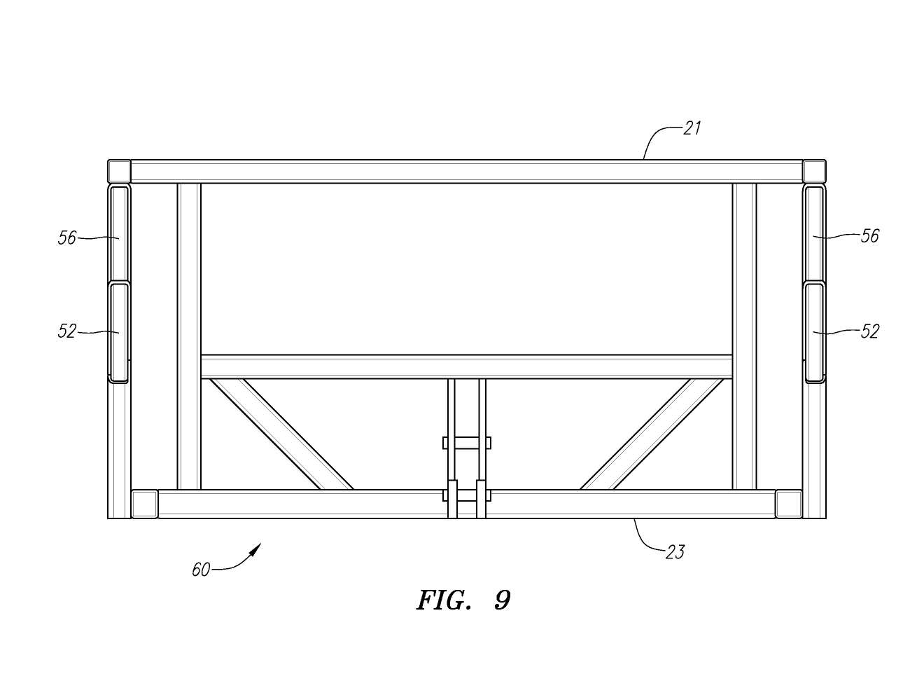

FIG. 9 illustrates a front view of the embodiment of a cargo bed 14 of FIG. 8. In FIG. 9, the head end structure 60 of the cargo bed 14 comprises upper cross piece 21 and lower cross piece 23. Also shown are the openings of the rear inclined channel tracks 56 and the front inclined channel tracks 52 where the front and rear lifting rollers 42 and 46 are mated.

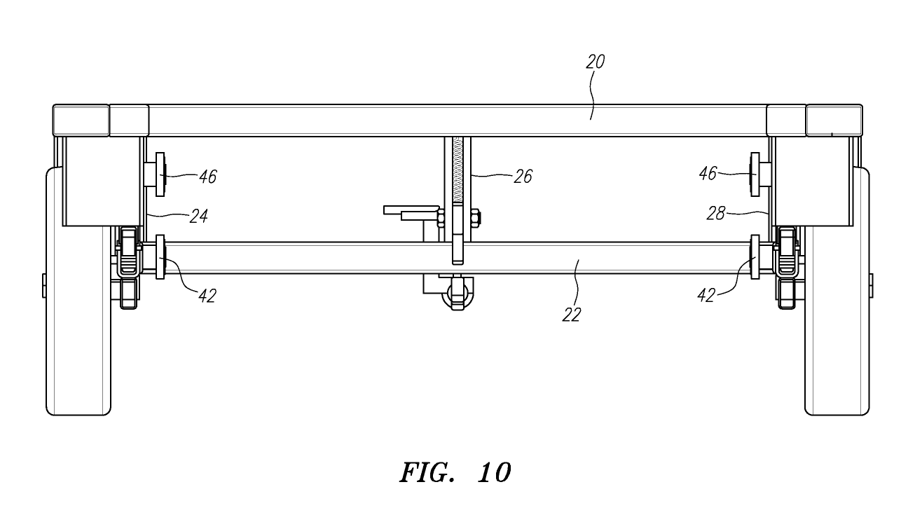

FIG. 10 illustrates a front view of an embodiment of a chassis 12 for use with a detachable level lift hauling system. In FIG. 10, the front end 18 of the chassis 12 comprises upper cross piece 20 and lower cross piece 22. Also shown are the front and rear lifting rollers 42 and 46.

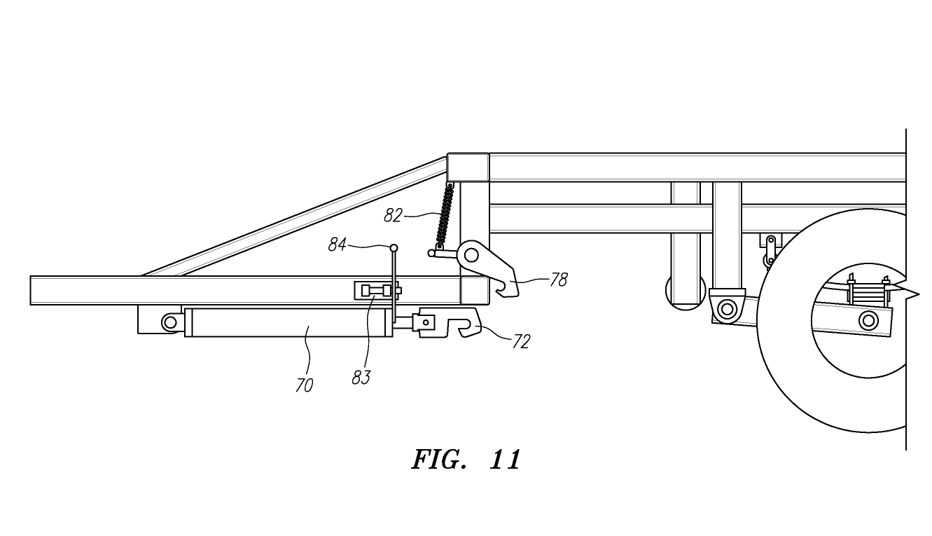

FIG. 11 illustrates a side view of a portion of the embodiment of the chassis 12 of FIG. 10. In the view shown in FIG. 11, the cargo bed 14 is lifted into an elevated position on the chassis 12, and then locked into place there. In FIG. 11, the locking hook 78 is shown without the pin 80 and the cargo bed 14. The spring 82 biases the locking hook 78 into a locking position. The latch 83 and holder 84 are also shown holding the hydraulic cylinder 70 and hook 72 into a locking position.

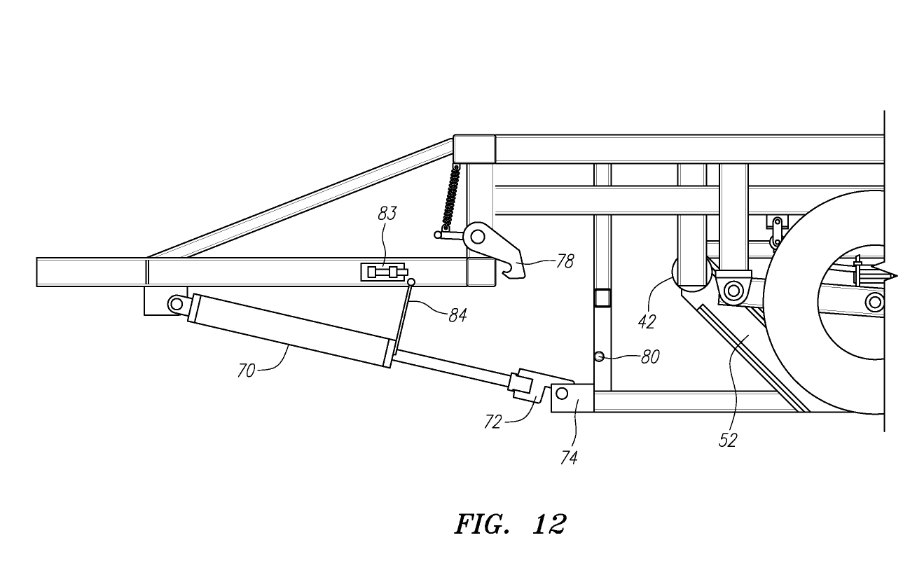

FIG. 12 illustrates a side view of a portion of an embodiment similar to FIG. 11, with its lifting device piston extended and latched to the cargo bed 14. In FIG. 12, the hydraulic cylinder 70 is extended and latched to the cargo bed 14, and is now ready for the cylinder 70 to be retracted, pulling the cargo bed 14 forwardly and upwardly into the transportation position. The locking hook 78 will be connected to the pin 80 when the cargo bed 14 is pulled into the transportation position. Also shown in FIG. 12 is the position of the front lifting roller 42 within the mouth of the front inclined channel track 52. Channel track 52 guides and lifts the cargo bed 14 as it is pulled forward. In FIG. 12 the latch 83 and holder 84 are shown unconnected, but will be connected after the cargo bed 14 is in pulled into the transportation position.

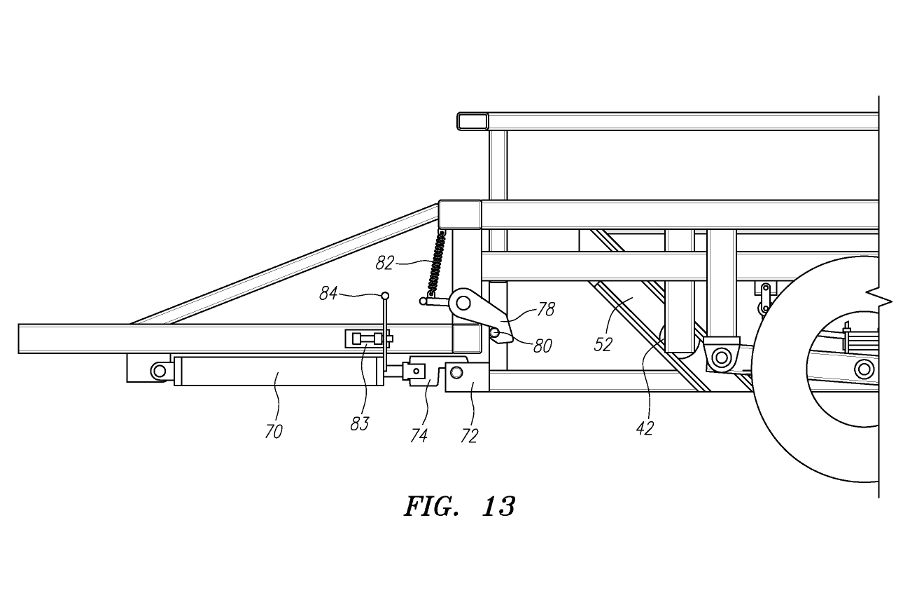

FIG. 13 illustrates a side view of a portion of another embodiment similar to FIG. 12, with the cargo bed 14 pulled up and elevated fully into the transportation position, and locked into place. Also shown in FIG. 13 is how the front lifting roller 42 travels along the front inclined channel track 52 during this operation. In FIG. 13 the latch 83 and holder 84 are shown in a connected position.

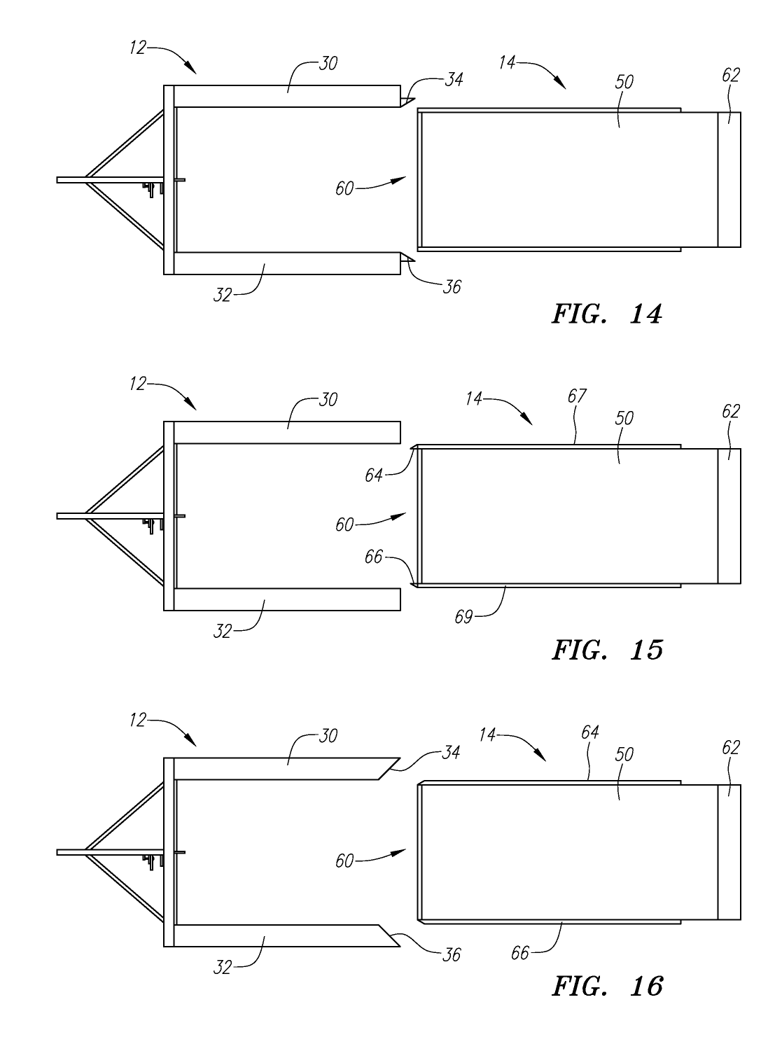

FIG. 14 illustrates a top view of an embodiment of a detachable level lift hauling system, where the beveled pieces are extensions of other pieces of the chassis 12. The embodiment shown in FIG. 14 is similar to the embodiment shown in FIG. 3, except the embodiment shown in FIG. 14 includes where the upper frame beams 30 and 32 incorporate the shape of the inwardly beveled pieces 34 and 36 into their own shapes, forming one piece on each side of the chassis 12 instead of two pieces coupled together. In the embodiment shown in FIG. 14, the cargo bed 14 may or may not have an outwardly beveled head end 60. In different embodiments, either the chassis 12 may have a back end comprising a bevel, the cargo bed 14 may have a head end comprising a bevel, or both. The back end of the chassis 12 and the head end of the cargo bed 14 may have a bevel.

FIG. 15 illustrates a top view of an embodiment of a detachable level lift hauling system, where the beveled pieces 64 and 66 are coupled to the head end of the cargo bed 14. The embodiment shown in FIG. 15 is similar to the embodiment shown in FIG. 3, except in the embodiment shown in FIG. 15 the upper frame beams 67 and 69 of the cargo bed 14 are separate pieces coupled to the outwardly beveled pieces 64 and 66. In the embodiment shown in FIG. 15, the chassis 16 may or may not have an inwardly beveled back end. In various different embodiments, either the chassis 12 may have a back end comprising a bevel, the cargo bed 14 may have a head end comprising a bevel, or both. The back end of the chassis 12 and the head end of the cargo bed 14 may have a bevel.

FIG. 16 illustrates a top view of another embodiment of a detachable level lift hauling system, where some beveled pieces are extensions of other pieces of the chassis 12, and other beveled pieces are extensions of the cargo bed 14. The embodiment shown in FIG. 16 is similar to the embodiment shown in FIG. 3, except the embodiment shown in FIG. 16 includes where the upper frame beams 30 and 32 incorporate the shape of the inwardly beveled pieces 34 and 36 into their own shapes, forming one piece on each side of the chassis 12 instead of two pieces coupled together. In the embodiment shown in FIG. 16, the cargo bed 14 does not have an outwardly beveled head end 60.

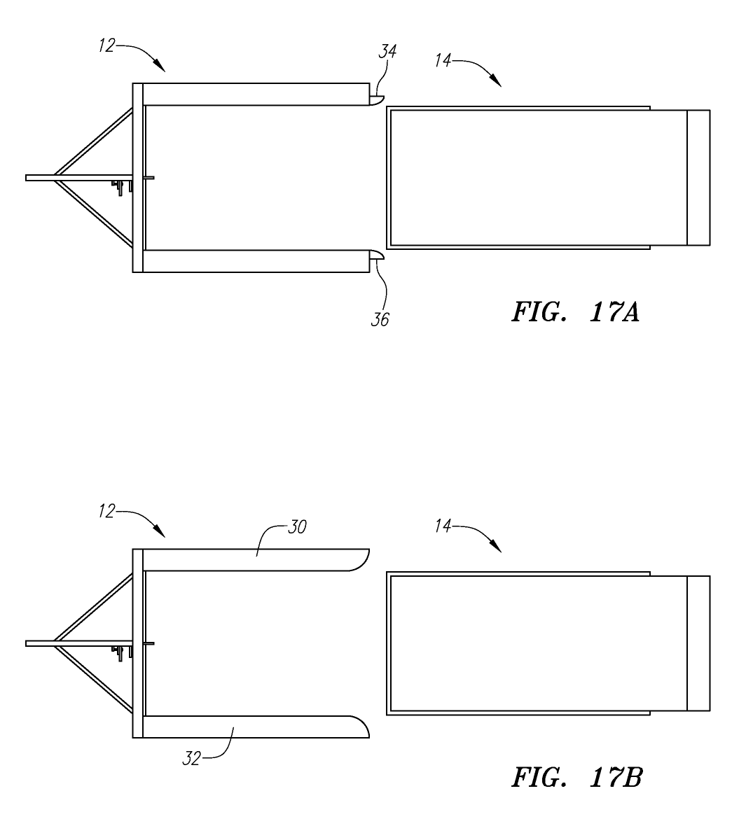

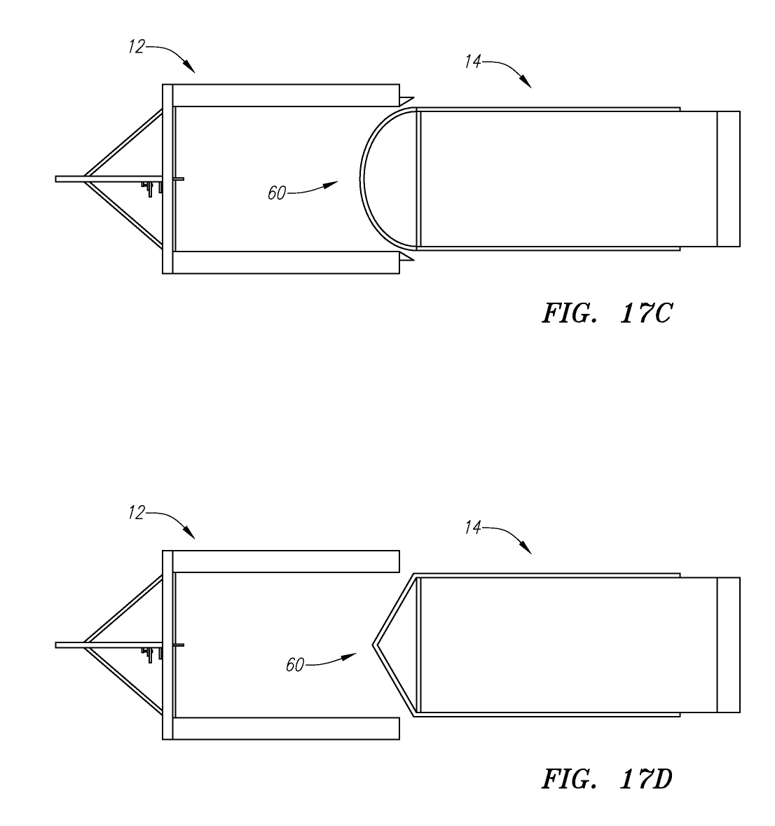

FIG. 17A illustrates a portion of a top view of an embodiment of a detachable level lift hauling system, where the beveled pieces are curved extensions of other pieces of the chassis 12. In the embodiment shown in FIG. 17A the inwardly beveled pieces 34 and 36 are curved.

FIG. 17B illustrates a portion of a top view of an embodiment of a detachable level lift hauling system, where the beveled pieces are curved extensions of the back end of the chassis 12. In the embodiment shown in FIG. 17B the back ends of the inwardly beveled upper frame beams 30 and 32 are curved.

FIG. 17C illustrates a portion of a top view of an embodiment of a detachable level lift hauling system, where the beveled piece comprises a curved shape. In the embodiment shown in FIG. 17C the cargo bed 14 comprises an outwardly beveled head end 60, where the outwardly beveled head end 60 is curved.

FIG. 17D illustrates a portion of a top view of an embodiment of a detachable level lift hauling system, where the beveled piece comprises a triangle shape. In the embodiment shown in FIG. 17D the cargo bed 14 comprises an outwardly beveled head end 60, where the outwardly beveled head end 60 is angled. In the embodiment of FIG. 17D, the outwardly beveled head end 60 is in the shape of a triangle.

The chassis 12 and cargo bed 14 of the hauling system 10 may be made of any material capable of supporting a load. Typically, the chassis 12 and cargo bed 14 of the hauling system 10 are made of metal, including but not limited to steel, stainless steel, aluminum, iron, other metals, or a combination of metals.

While various embodiments of a level lift trailer with detachable cargo bed and its respective components have been presented in the foregoing disclosure, numerous modifications, alterations, alternate embodiments, and alternate materials may be contemplated by those skilled in the art and may be utilized in accomplishing the various aspects of the present invention. Thus, it is to be clearly understood that this description is made only by way of example and not as a limitation on the scope of the invention.

1. A hauling system, comprising:
a chassis having an open space in the center, and inwardly beveled guides disposed on opposite sides of the chassis at a mouth to the open space; and
a removable cargo bed, sized to fit into the open space and including outwardly beveled guides disposed on opposite sides of a front of the removable cargo bed so as to be operably received by the inwardly beveled guides when the cargo bed is initially being received into the open space.

2. The hauling system of claim 1, wherein the chassis is a trailer.

3. The hauling system of claim 1, wherein the cargo bed is a container.

4. The hauling system of claim 1, wherein the hauling system is a detachable level lifting trailer system.

5. The hauling system of claim 1, wherein the chassis further comprises a tongue structure coupled to a head structure.

6. The hauling system of claim 5, wherein the chassis further comprises a hydraulic cylinder coupled to the tongue structure and the cargo bed for raising up the cargo bed to a transport position.

7. The hauling system of claim 6, wherein the cargo bed further comprises two side walls, where the side walls comprise a plurality of inclined channel tracks disposed to the side walls, each of the inclined channel tracks is sized to receive one of the lifting rollers, wherein the lifting rollers are located in the inclined channel tracks when the cargo bed is raised up to a transport position.

8. The hauling system of claim 7, wherein a lifting roller disposed nearer to the mouth of the chassis is at a position higher than that disposed nearer to a front head structure.

9. The hauling system of claim 6, wherein the cargo bed further comprises:
two side walls, a head end, and a plurality of inclined channel tracks angled substantially at 45 degrees, each of the inclined channel tracks is parallel to one another and disposed on the outer surface of the side walls, each of the inclined channel tracks are purposed to receive a lifting roller from the head end of the cargo bed and extending to the upper ends of the inclined channel tracks.

10. The hauling system of claim 6, wherein the hydraulic cylinder further comprises a hydraulic cylinder shaft and a hook; wherein the hydraulic cylinder is powered or pressured to move between an up and a down position.

11. The hauling system of claim 10, wherein the hydraulic cylinder is powered or pressured to move the cargo bed between an up and a down position.

12. A detachable level lift hauling system, comprising:
a chassis having a front end, a back end, and an open space in the center;
a detachable cargo bed, sized to enter through the back end and fit into the open space;
wherein the detachable cargo bed is secured to the front end of the chassis.

13. The detachable level lift hauling system of claim 12, wherein the detachable cargo bed is secured to the front end by a hook.

14. The detachable level lift hauling system of claim 13, wherein the hook is coupled to the front end of the chassis.

15. The detachable level lift hauling system of claim 14, wherein the front end of the chassis further comprises a spring, wherein the spring biases the hook into a locking position with a bar on the cargo bed.

16. The detachable level lift hauling system of claim 12, wherein the cargo bed is lifted into an elevated position on the chassis, and then secured.

17. A hauling system, comprising:
a chassis having an open end and an open space in the center;
a removable cargo bed sized to fit into the open space; and
wherein at least one of either the chassis or the removable cargo bed include alignment guides to move the cargo bed into alignment for loading into the open space.

18. The hauling system of claim 17, wherein the alignment guides further comprise a plurality of beveled pieces disposed on a back end of the chassis.

19. The hauling system of claim 18, wherein the alignment guides further comprise a plurality of beveled pieces disposed on a front end of the cargo bed.

20. The hauling system of claim 17, wherein the chassis is a trailer.

21. The hauling system of claim 17, wherein the cargo bed is a container.

22. The hauling system of claim 17, wherein the hauling system is a detachable level lifting trailer system.

23. The detachable level lift hauling system of claim 12, wherein the chassis further comprises a tongue assembly coupled to the front end, and a hydraulic cylinder coupled to the tongue assembly, wherein the hydraulic cylinder further comprises a hydraulic cylinder shaft and a hook.

24. The detachable level lift hauling system of claim 23, wherein the hydraulic cylinder is powered or pressured to move between an up position and a down position.

25. The hauling system of claim 17, wherein the chassis further comprises a tongue assembly coupled to a front end, and a hydraulic cylinder coupled to the tongue assembly, wherein the hydraulic cylinder further comprises a hydraulic cylinder shaft and a hook.

26. The hauling system of claim 25, wherein the hydraulic cylinder is powered or pressured to move between an up position and a down position.
